(19) United States
(12) Patent Application Publication
(10) Pub. No.: US 2019/0371071 A1
(43) Pub. Date: Dec. 5, 2019

(54) PRECISE PLACEMENT OF AND ANIMATION CREATION FOR VIRTUAL OBJECTS IN AN ENVIRONMENT USING A TRACKABLE THREE-DIMENSIONAL OBJECT

(71) Applicant: Merge Labs, Inc., San Antonio, TX (US)

(72) Inventor: Franklin A. Lyons, San Antonio, TX (US)

(21) Appl. No.: 16/425,589

(22) Filed: May 29, 2019

Related U.S. Application Data
(60) Provisional application No. 62/679,146, filed on Jun. 1, 2018.

(51) Int. Cl. G06T 19/00; G06T 7/246; G06T 7/73; G06T 19/20; G06T 13/20

(52) U.S. Cl. CPC G06T 19/006; G06T 7/246; G06T 7/73; G06T 19/20; G06T 2207/10028; G06T 2219/2004; G06T 2219/2016; G06T 2207/30204; G06T 2207/10048; G06T 13/20

(57) ABSTRACT

A system for examining a virtual object, and precisely placing it in the user's environment using a trackable three-dimensional physical object and a computing device in communication with a camera and display is disclosed. Manipulation of the physical object shows corresponding actions in a displayed associated virtual object. A stationary copy of the virtual object is placed in the user's environment at precisely the location and orientation of the physical object. The virtual object and its path may be realistically animated, and any interaction may be recorded.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### RELATED APPLICATION INFORMATION

This application claims priority to U.S. provisional patent application No. 62/679,146 entitled “Precise Placement and Animation Creation of Virtual Objects in a User's Environment Using a Trackable Physical Object” filed Jun. 1, 2018 which is incorporated herein by reference.

This application is related to related to U.S. nonprovisional patent application Ser. No. 15/860,484 entitled “Three-dimensional Augmented Reality Object User Interface Functions” filed Jan. 2, 2018 which IS incorporated herein by reference.

### BACKGROUND

### Field

This application relates to augmented reality objects and interactions with those objects along with the physical world.

### Description of Related Art

Augmented reality (AR) is the blending of the real world with virtual elements generated by a computer system. The blending may be in the visual, audio, or tactile realms of perception of the user. AR has proven useful in a wide range of applications, including sports, entertainment, advertising, tourism, shopping and education. As the technology progresses it is expected that it will find an increasing adoption within those fields as well as adoption in a wide range of additional fields.

Virtual reality (VR) is a computer-generated simulation of a three-dimensional image or environment that can be interacted with in a seemingly real or physical way. Usually special electronic equipment, such as a helmet with a screen inside is required for a truly immersive VR experience.

Virtual and augmented reality apps and software are growing into many fields and industries. Doctors, scientists, consumers and even teachers are using virtual and augmented reality daily in their fields. A doctor can prepare and even perform surgeries using augmented reality in the form of augmented reality trajectory lines or virtual reality MRI's showing a path for the planned surgery.

There are currently available systems (e.g., mobile apps) for placing virtual objects in the user's environment using surface identifying technologies included in smartphones. For example, a shopper searching for a new couch can map his living room with his smartphone and view virtually placed, appropriately-sized couches as they would look in real life to help him decide which couch to buy. That system measures the size of the space for the couch, but it is a rough estimate that gives the viewer a general idea if the couch would fit in the space. This technology could not be used for precise measurement and placement.

There also exists currently the ability to show virtual objects at the location and position of a two-dimensional marker. Also, in the consumer market, manufacturers and retail stores provide catalogues and advertisements that include markers. A potential buyer can view the marker with his smartphone and see a virtual three-dimensional image of the product for further inspection. Precisely anchoring a virtual object to a surface is not easily accomplished with current technology. A user may go through multiple attempts to place a virtual object on a surface before achieving the desired placement and position. Further current applications fall short in the ability to place a virtual object in space that is not tied to a planar surface. What is needed is a system that allows for both the ability to see fine detail through examination of a virtual object naturally in a user's hand combined with the ability to precisely place the virtual object in the user's environment independent of a planar surface.

### DESCRIPTION OF THE DRAWINGS

FIG. 1 shows a system for precisely anchoring a virtual object using a trackable three-dimensional physical object.

FIG. 2 is example set of sides for a cube that may be used as the three-dimensional trackable physical object with an embodiment of the system.

FIG. 3 is a flowchart showing the process of an embodiment of the system placing a copy of the associated augmentation at the location of the trackable three-dimensional physical object.

FIG. 4 is a flowchart showing the process of an embodiment that anchors a copy of the hand-held associated augmentation at the location of the trackable three-dimensional physical object and editing the scale of the copy.

FIG. 5 is a flowchart of the process of an embodiment that anchors a life-sized copy of the hand-held associated augmentation at the location of the trackable three-dimensional physical object.

FIG. 6a-6c are photographs showing how various orientations of the virtual object (a dinosaur) change as the cube orientation changes in relation to an already anchored copy of the virtual dinosaur.

FIG. 7 is a photograph showing placement of a virtual object precisely by placing the cube on a surface.

FIG. 8 is a photograph showing the ease and precision of performing 90-degree rotations using the cube.

FIG. 9 illustrates an embodiment that also incorporates a server with a virtual objects library.

FIG. 10 illustrates how the path of the cube determines the path of an animated virtual object using an embodiment of the disclosed system.

FIG. 11 shows an example of a virtual object library interface that allows the user to associate a virtual object with the cube.

FIG. 12 shows an example of a virtual Rube Goldberg machine that may be created using an embodiment of the disclosed system.

FIG. 13 is an example of a virtual character library that a user could view to select a virtual character to associate with the cube in creating a scene animation in one embodiment of the disclosed system.

FIG. 14 is an example character animation library showing various predefined movements associated with available virtual characters in an embodiment of the disclosed system.

FIG. 15 shows an example animation movement library assigning specific movements of the cube to predefined movements associated with a specific virtual character.

FIG. 16 is an example of an animation created using the exemplary animation embodiment of the disclosed system.

FIG. 17 is a flowchart of the process of an embodiment that allows the user to plot varying segments of assigned animation to a virtual object or many virtual objects, each having a library of animation characteristics.

FIG. 18 is a flowchart of the process of an embodiment that tracks movement of the trackable physical object to control the animation of the associated virtual object.

Throughout this description, elements appearing in figures are assigned three-digit reference designators, where the most significant digit is the figure number and the two least significant digits are specific to the element. An element that is not described in conjunction with a figure may be presumed to have the same characteristics and function as a previously-described element having a reference designator with the same least significant digits.

### DETAILED DESCRIPTION

A system for examining a hand-held virtual object and precisely placing it in the user's environment using a computing device in communication with a camera and visualization system and a trackable three-dimensional physical object is disclosed. Manipulation of the trackable three-dimensional physical object controls corresponding actions in the virtual object being displayed. An anchored copy of the virtual object is placed in the user's environment at the precise location of the trackable physical object. Realistic animations can be created and recorded using this system.

The current system provides a natural interaction with a virtual object that a user would experience if he were holding the actual item in his hand combined with the ability to precisely anchor that virtual object in the world around him. The user can also control animation of the virtual object and easily and intuitively create virtual scenes. Once a virtual object is associated with the trackable three-dimensional physical object, a user can examine the associated virtual object up close from all sides and angles by easily turning the trackable physical object in his hand, even holding it closer to inspect fine details. He can then create a copy of that virtual object precisely anchored to any location in his environment using the trackable three-dimensional physical object to position and orient it.

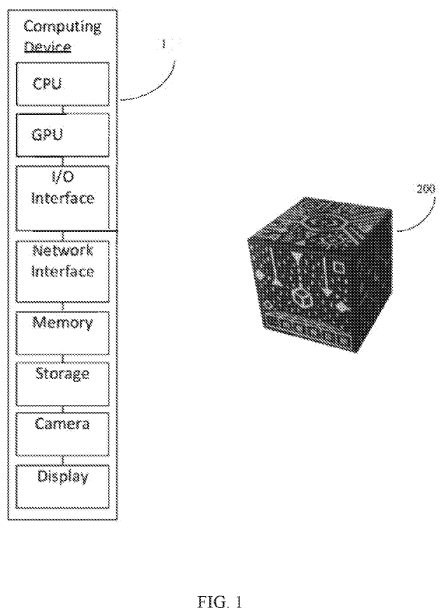

The system involves the use of a computing device with or in communication with a processor, a display, a memory, a camera, a user interface, and possibly a network. FIG. 1 shows one embodiment of the system with a computing device 100 and an example of a trackable three-dimensional physical object 200. In this example a cube 200 is used as the three-dimensional physical object, but there is no limitation that the three-dimensional physical object be a cube. A cube does present a high level of functionality for the system as discussed later, though any other three-dimensional object with multiple sides can be used. A mobile computing device 100 such as a smartphone usually includes all of the hardware required of a computing device for the disclosed system, though the system is not limited to a smartphone, in fact the various systems attributed to the computing device do not have to be housed in the same housing and instead could be various components in communications with each other.

Processor(s) may be implemented using a combination of hardware, firmware, and software. Processor(s) may represent one or more circuits configurable to perform at least a portion of a computing procedure or process related to 3D reconstruction, Simultaneous Localization And Mapping (SLAM) or similar functionality, tracking, modeling, image processing, animation etc. and may retrieve instructions and/or data from memory.

The memory may include a combination of volatile and/or non-volatile memory including read-only memory (ROM), static, dynamic, and/or magnetoresistive random access memory, and nonvolatile writable memory such as flash memory. The memory may store software programs and routines for execution by the CPU or GPU (or both together). These stored software programs may include operating system software. The operating system may include functions to support the I/O interface or the network interface, such as protocol stacks, coding/decoding, compression/decompression, and encryption/decryption. The stored software programs may include an application or “app” to cause the computing device to perform portions or all of the processes and functions described herein. The words “memory” and “storage”, as used herein, explicitly exclude transitory media including propagating waveforms and transitory signals.

Storage may be or may include non-volatile memory such as hard disk drives, flash memory devices designed for long-term storage, writable media, and other proprietary storage media, such as media designed for long-term storage of image data.

The camera is an electronic device capable of capturing ambient light to produce an image of those objects within its view. The camera is shown as a single camera, but may be a dual-lens or multi-lens camera. Likewise, the word camera is used generally, but the camera may include infrared lighting, a flash or other pointed light source, an infrared camera, depth sensors, light sensors, or other camera-like devices capable of capturing images or detecting three-dimensional objects within range of the camera. Though camera is described as a visual imaging camera, it may include additional or other capabilities suitable for enabling tracking. For example, lasers and/or sound may be used to perform object tracking using technologies like LIDAR and Sonar. Though neither technology involves a “camera” per se, both may be used to augment or to wholly perform object tracking in three-dimensional space.

The display is an electronic device that incorporates electrically-activated components that operate to form images visible on the display. The display may include backlighting (e.g. an LCD) or may be natively lit (e.g. OLED). The display is shown as a single display but may actually be one or more displays. Other displays, such as augmented reality light-field displays that project lights into three-dimensional space or appear to do so, or other types of projectors (actual and virtual), may be used. Retinal projection may also be used, in which case, a display may not be required.

The display may be accompanied by lenses for focusing eyes upon the display and may be presented as a split-screen display to the eyes of a viewer, particularly in cases in which the computing device is a part of an AR/VR headset. The AR/VR headset is an optional component that may house, enclose, connect to, or otherwise be associated with the computing device. The AR/VR headset may, itself, be a computing device, connected to a more-powerful computing device, or the AR/VR headset may be a stand-alone device that performs all of the functions discussed herein, acting as a computing device itself. Some embodiments of the system include an AR/VR headset or Head Mounted Display (HMD) that enhances the user's experience. Incorporating an HMD into the system allows the user to use both hands to manipulate the three-dimensional physical object, to ensure the perfect pose and placement of an associated virtual object in the physical or virtual environment, based on the precise placement of the three-dimensional physical object. Further for embodiments of the invention involving animation, having two free hands to manipulate the trackable physical object becomes important.

A trackable physical three-dimensional object acts as a placeholder for insertion of an associated virtual object the user has selected, a tool to exactly position and orient the virtual object, a controller to animate a virtual object, and a tangible object to naturally manipulate as the user would if he were holding the virtual object. Multiple interfaces exist for placing and manipulating virtual objects; the currently disclosed system uses a trackable physical object as an interface, making it very user friendly and intuitive, as humans have been utilizing gross and fine motor skills to pick up, arrange, and set down objects since birth. Children in imaginative play have picked up blocks or other items and spun them through the air, pretending they are airplanes, rocket ships, dragons, or endless other things. The disclosed system allows that child to appear to hold that dragon in his hand as he flies it through the air. He can also record a scene with all of the previously mentioned imaginary augmented items places or animated in his environment or even a virtual one he created.

The trackable three-dimensional physical object can be a triangular prism, a pyramid, a rectangular prism, a cube, or any other three-dimensional shape. The trackable three-dimensional physical object can be an object associated with a particular game or application: a wand, a hammer, an ax, a piece of sporting equipment, etc. The term “cube” is used as a preferred shape in embodiments of the system, but any three-dimensional object can be used in place of a cube, the system is not limited by the term “cube”. For brevity and to avoid confusion between the trackable physical object and the virtual object, throughout the remainder of the description the term “cube” is used in place of the trackable three-dimensional physical object.

A cube 200 has several characteristics that make it uniquely suitable for tracking purposes. Notably, only six sides are present, but each of the six sides may be unique and relatively differentiable from one another. The differentiation can be accomplished in many different and trackable ways (even if another shape is used in place of the cube, similar tracking methods can be used). For example, a cube 200 may have different colors on each side; only six colors are required for differentiation based upon color-use or lighting-use of particular colors.

This enables computer vision algorithms to easily detect which side(s) are facing the camera, and because the layout of colors is known, and certain colors are designated as up, down, left, right, front, and back, the orientation of the cube 200 can be matched one-to-one with a virtual object and easily tracked. The computer vision can predict which side is being presented based on the movement of the cube in any direction with the known layout of markers.

Similarly, computer-readable (or merely discernable) patterns may be applied to each side of a cube 200 without having to account for more than a total of six faces. If the number of faces is increased, the complexity of detection of a particular side—and differentiating it from other sides or non-sides—increases as well. Also, if keeping the three dimensional physical object 200 handheld in size, the total surface area for a “side” decreases as more sides are added, making computer vision side-detection algorithms more difficult, especially at different distances from the camera, because only so many unique patterns or colors may be included on smaller sides. Further, the smaller the side, the higher the likelihood for occlusion by the user's hand which increases the potential for losing tracking of the trackable object. The trackable three-dimensional physical object (“trackable object” or “cube”) of the disclosed system and method is highly intuitive as an interface and removes a technology barrier that can exist in more standard software-based user interfaces.

Similarly, if fewer sides are used (e.g. a triangular pyramid), then it is possible for only a single side to be visible to computer vision at a time and, as the pyramid is rotated in any direction, the computer cannot easily predict which side is in the process of being presented to the camera. Therefore, it cannot detect rotational direction as easily. More of each “side” is obscured by individuals holding the trackable three-dimensional object because it simply has fewer sides to hold. This makes computer vision detection more difficult.

In embodiments using markers for computer vision tracking, the markers used on the various faces of the cube (or other trackable three-dimensional physical object) can be many different designs, colors, patterns, and formats. They can be any black and white designs or patterns. The patterns can include large and small parts to increase accuracy of tracking, with the patterns on each side of the object being unique. Markers can simply be solid colors recognizable by computer vision, with each side having a different color, and the arrangement of the colors being known. Unique QR codes can be created for each side, with a known arrangement. The trackable object may bear markers that allow for at least two detection distances and are capable of detection by relatively low-resolution cameras in multiple, common lighting situations (e.g. dark, light) at virtually any angle.

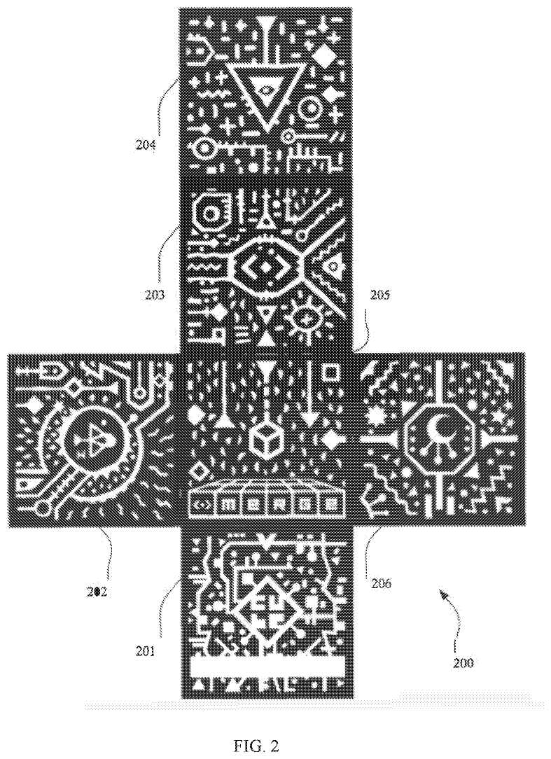

The technique of including at least two (or more) sizes of markers for use at different detection depths, overlaid one upon another in the same marker, is referred to herein as a “multi-layered marker.” The use of multiple multi-layered markers makes interaction with the cube (and other objects incorporating similar multi-layered markers) in augmented reality environments robust to occlusion (e.g. by a holder's hand or fingers), rapid movement, and provides strong tracking through complex interactions with the cube 200. In particular, high-quality rotational and positional tracking at multiple depths (e.g. extremely close to a viewing device and at arm's length or across a room on a table) is possible through the use of multi-layered markers. Other electrical methods of tracking using lights or sensor(s) is also anticipated by the invention, though using markers as discussed above is a less complex and less expensive implementation of the invention. FIG. 2 shows example sides of cube 200 with unique sides 201, 202, 203, 204, 205, and 206 including multi-layered markers for optimal computer vision tracking in one embodiment of the disclosed system and method.

All of the foregoing enables finely-grained positional, orientation, and rotational tracking of the cube 200 when viewed by computer vision techniques at multiple distances from a viewing camera. When held close, the object's specific position and orientation may be ascertained by computer vision techniques in many lighting situations, with various backgrounds, and through movement and rotation. When held at intermediate distances, due to the multi-layered nature of the markers used, the object may still be tracked in position, orientation, through rotations and other movements. With the high level of tracking available, the cube 200 may be replaced within augmented reality scenes with other, generated three-dimensional objects. Even minute motions of the cube can be tracked and shown in the virtual object on the display. Interactions with the cube 200 may be translated in the augmented reality environment (e.g. shown on an AR headset or mobile device, or shown on a display of a mobile computing device 100) and, specifically, to the virtual object within the scene and for which the cube 200 is a real-world stand-in.

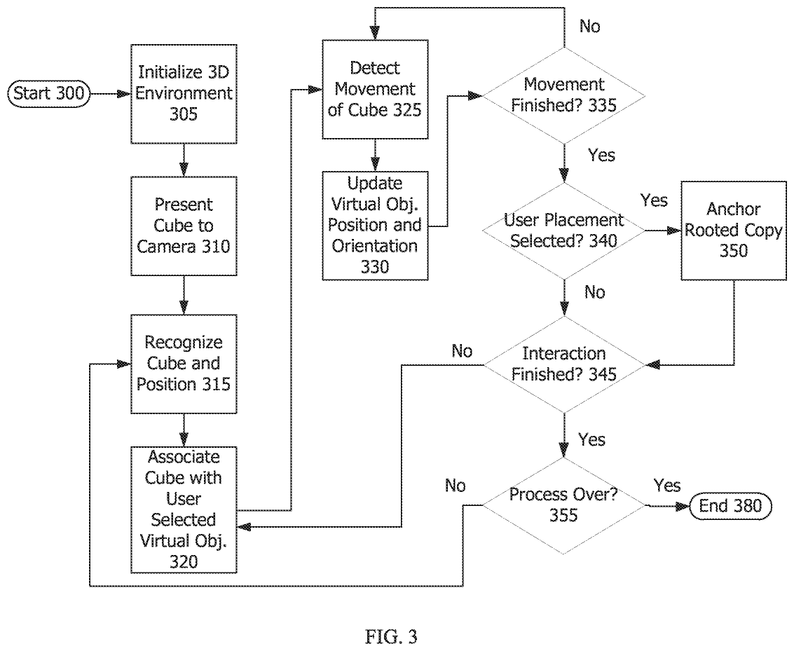

Referring now to FIG. 3, a flowchart for a method involving a processor for anchoring a virtual object in an augmented reality environment is shown. The flow chart has both a start 300 and an end 380, but the process is cyclical in nature. The process may take place many times while a computing device is viewing and tracking a cube or other trackable three-dimensional object; numerous virtual objects may be placed. There is no limit to the number of virtual objects that may be examined and placed. Also not shown in the process, but a feature of some embodiments of the invention is the ability to record the experience and save the recording for playback and/or sharing later. Recording can be selected at any point in this process or other processes described in this disclosure.

The first step in the process 305 upon starting is to initialize the three-dimensional environment. In one embodiment a camera in communication with a computing device (e.g., a smartphone) along with associated software maps the user's environment in an initialization process. The user's environment is shown through the camera feed on the display associated with the computing device.

The next step 310 is to present the cube (or other trackable three-dimensional object) to the camera in communication with the computing device. In the most common case, this camera will be the camera on a mobile device (e.g. an iPhone®) that is being used as a “window” through which to experience the augmented reality environment. The camera does not require specialized hardware and is merely a device that most individuals already have in their possession on their smartphones. In this and other examples, computing device, mobile computing device, and smartphone are used interchangeably. These are merely examples; no limitations of any of the group should be imposed on the disclosure as a whole.

Next, the cube is recognized by the camera of the computing device at 315 while the position, orientation, and motion begin being tracked. At this stage, not only is the cube recognized as something to be tracked, but the particular side, face, or marker (and its orientation, up or down, left or right, front or back, and any degree of rotation) is recognized by the computing device. The orientation is important because the associated software also knows, if a user rotates the object in one direction, which face will be presented to the camera of the computing device next and can cause the associated virtual object to move accordingly. At 315, the tracking, position, orientation and motion (including rotation) begin being tracked by the computer vision software in conjunction with the camera.

Next at 320, the cube may be associated with a virtual object which is shown on the display. The cube may be a stand-in for an avatar, an animal, a statue, an industrial part, a piece of art, a product for sale, or other type of object which could be automatically selected based on the computer program being performed. In other cases, the associated virtual object may be manually-selected (e.g. through interaction with a menu on the display of the computing device) from a library of virtual items. The scale of the virtual object could be the real-life size of the object if it is hand-held, a scaled down version if the object is large (e.g., an airplane), or a scaled-up version of the object if it is small or microscopic (e.g., a cellular structure).

Once the three-dimensional object is associated with a particular virtual object at 320, movement of the cube may be detected at 325. Movement can be translational “away from” a user (or the display or camera) or toward the user, in a rotation about an axis, in a rotation about multiple axes, to either side or up or down. The movement may be quick or may be slow. The tracked movement of the cube is updated in the associated virtual object at step 330. This update in movement of the virtual object to correspond to movement of the cube may happen in real-time, with no observable delay. The movement is not restricted to incremental degrees or stepped, predetermined points; rather the motion of the virtual object is the natural motion of the cube in the user's hand and can be manipulated in the same way, as if holding the virtual object.

At decision step 335, a determination whether the particular movement is finished is made by the associated computing device tracking the movement of the cube. This may be through a deselection or completed selection by the cube through an action (e.g. click, or swipe or similar action) or may be through a timeout (e.g. a predetermined number of seconds elapse without change, then a particular action or user interface element is selected). If the particular movement is not finished (“no” at 335), then the process continues to detect the movement at 325.

If the particular movement is finished (“yes” at 335), then the process continues to determine if the user has selected to anchor a copy of the virtual object at the location of the cube at step 335. The user can make this selection using a directive on the user interface such as “place” or “stamp” or any action that would allow the user to anchor a copy of the virtual object. If the user has made a selection to anchor a copy of the virtual object (“yes” at 340), then the process continues to step 340 where a copy of the virtual object is anchored at the location and position of the cube. Whether the cube is placed on a surface in the physical environment or held in the air, the three-dimensional virtual object will be placed exactly at the location and position of the cube. This embodiment allows for very precise placement and orientation of virtual items in a user's environment.

The cube can be in the air when the selection to anchor a copy of the virtual object is made in which case, the virtual object would appear to be floating there. If the cube is placed on a physical surface when anchoring the copy, the virtual object will appear to be standing in that exact place and position on the physical surface. The cube can be placed against or on other surfaces that a standard placing system that only recognizes horizontal planes in the user's environment would not allow. The cube can be placed on a chair or on a small ledge or above a structure that the camera would not recognize as a planar surface, or up against other objects in the environment. Cubes can be stacked on top of one another. Multiple cubes could be arranged to place various virtual objects in relation to each other easily and precisely, as the cubes have a known, precise shape and can be placed exactly next to each other or other objects in a user's environment. Once anchoring is selected in this embodiment of the system, movement of the cube, while still associated with the chosen virtual object is not associated with the created anchored copy of the virtual object. Therefore, further movement of the cube will not affect the position of the created anchored copy. If the camera is moved away from the field of view where the anchored copy was placed, and then moved back to the field of view of the anchored copy, the virtual object will remain in its anchored position and still be visible on the display.

If the user has not made a selection to anchor a copy (“no” at 340), the process continues to decision step 345, where a determination whether the interaction is complete is made by the associated computing device tracking the movement of the cube. If it is determined that the interaction is not over (“no” at 345), the process cycles back to step 320, allowing the user to associate the cube with a different virtual object (the user can also continue with the same virtual object to create multiple copies of that virtual object placed in chosen locations in the augmented reality environment).

When it is determined at step 345 that the overall interaction is finished (“yes”) at decision step 345, then the computing device may determine whether the overall process is finished at decision step 3555. At this step, the software may simply be closed, or the mobile device or other computing device be put away. If so (“yes” at 355), then the process is complete at end point 380. If not, (“no” at 355), then the three-dimensional object may have been lost through being obscured to the camera, may have moved out of the field of view or may otherwise have been made unavailable. Any anchored virtual objects will remain in place. The process may continue (“no” at 355) with recognition of the cube (or other trackable three-dimensional physical object being used) and its position at 315, then the process may continue from there.

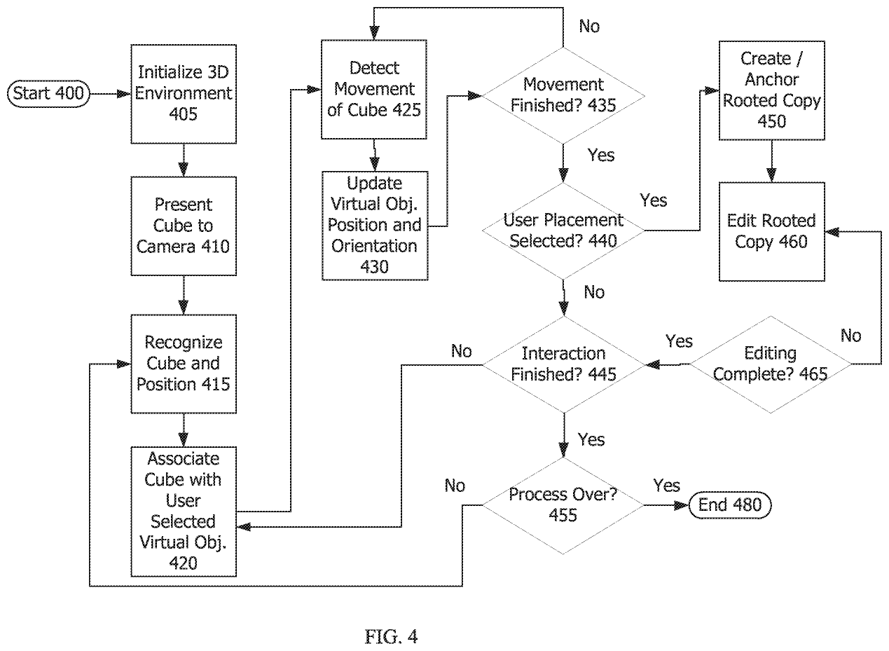

Another embodiment of the system provides for the ability to edit the scale of the copy of the virtual object once placed at the location of the cube. The process for this embodiment is similar to the previous embodiment, at least through the step of anchoring a rooted copy. FIG. 4 shows a flow chart of the process for creating a copy of the virtual object rooted to the location of the cube (or other trackable three-dimensional object) that the user can then edit by scale.

The process starts at 400 and ends at 480. The discussions above covering the process of FIG. 3 also apply to the process of FIG. 4. The process involves the steps of: initializing the three-dimensional environment 405, presenting the cube to the camera 410, recognizing the position and orientation of the cube 415, associating a virtual object with the cube 420, tracking the movement of the cube 425, updating the virtual object's position and orientation based on the movement of the cube 430, a determination of the movement of the cube being halted 435, and user selection to anchor a copy 450.

This process includes an additional step at 460 to edit the copy of the virtual object. Like the embodiment in FIG. 3, the selection can be made by the user in a number of ways. Once the user has chosen to “place” or “stamp” the virtual item, creating an anchored copy, the user can then choose an “edit” or “scale” feature at step 460 (or any other name) that allows for sizing of the virtual object. Sizing can be accomplished in a number of ways. In one embodiment, a number of sizes of the virtual object can be scrolled through with step-like functionality on a user interface of the computing device (e.g., a touchscreen of a smartphone). Other embodiments can include more precise scaling with almost indeterminable differences in the sizes that the user can adjust by sliding a finger on a touch screen of a mobile computing device to create a touch input. The user interface can include predefined size choices that the user selects, or a sliding bar to allow for more precise scaling. In one embodiment there is no visible sliding scale, but the user can drag an object that creates a touch input (such as a finger) up or down on a touchscreen of a mobile computing device to increase or decrease the size of the virtual object with ease. The motion of the finger or stylus on the screen can be up and down, left and right, swiping, or any other movement known in the art.

The next decision step 465 determines whether the editing is complete. If “yes” at 465, the process joins the previously described process in determining whether the interaction is finished 445, and if so whether the process is finished 455. If the editing is not complete (“no” at 465), editing continues until complete. Once editing is complete, if the interaction is not finished, (“no” at 445) the process cycles back to associating a virtual object with the cube (420) (from a library of virtual objects). As described above the user might keep the same virtual object and create more anchored copies in other locations in the augmented reality environment, or the user may choose to associate a new virtual object. Once all steps are finished, the process ends at 480.

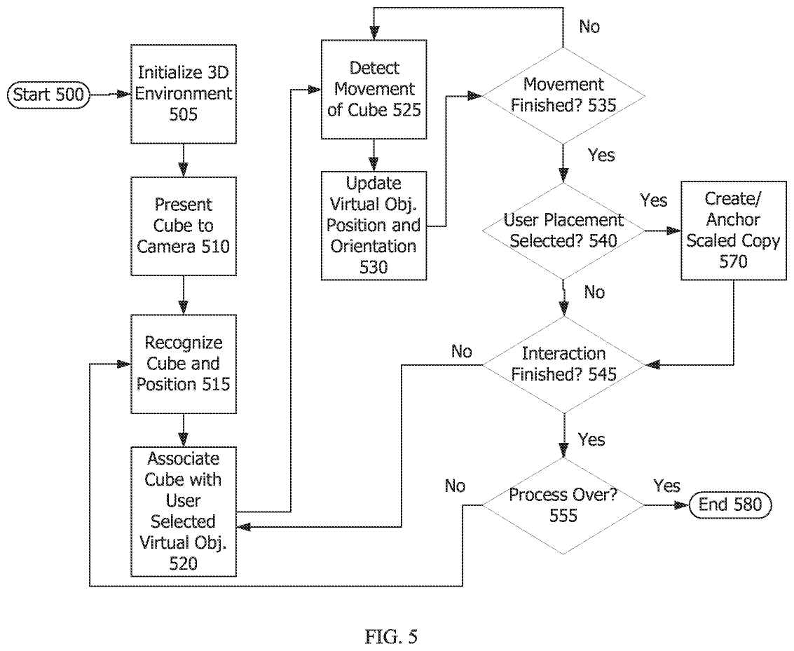

In one embodiment with the process shown in FIG. 5, the copy of the virtual object placed at the location of the cube is scaled to the exact dimensions of the actual object from which the virtual object is modeled. In this way the current system can be utilized in many fields and industries. For a prospective buyer for example, he could look at a life-sized, actual scale virtual three-dimensional watch superimposed on the cube. He could hold it closer to the camera (such as in a head mounted display or on a smartphone) to see fine details and get an idea of the size of the diamonds around the face of the watch. He can see how the actual scale would look compared to his wrist. This type of handheld virtual item would stay its same size when anchored in the environment.

The size of the virtual object does not have to remain the same handheld and placed. For example, an educator teaching a class in art history could give students a miniature virtual “Bust of Nefertiti” to examine from all sides and angles through manipulation of the cube in their hands. Using a cube and software on a smartphone, students could see all of the fine details of the sculpture up close by moving the cube closer to the camera. When placing the object, it can be placed in its actual size in real life. The process for this embodiment is very similar to those illustrated by FIG. 3 and FIG. 4 (the corresponding process elements correlating to 500-555), but upon input of the user via the user interface, there is the added step of scaling the virtual object to the actual known size 570 the object would be in the physical world. Other systems that place virtual objects fall short in both precise placement of virtual objects as well as exact sizing of those virtual objects due to estimations used in measuring the environment, or inconsistencies in the printing of paper markers. Having a definite, known size of the trackable three-dimensional physical object as a bridge to placing the virtual object ensures that the virtual object is shown to scale precisely.

Going back to the art history example, to get an idea of the actual size of the sculpture, students may set the cube on a table and through the user interface, select to “place” it (or any other directive used on the user interface). A life-sized, near 19-inch version would then appear to be placed at the cube's location on the table allowing the students to see the sculpture from all sides as they would at the Neues Museum in Berlin, but without the protective glass. Further, the cube would not even need to be placed on a surface, the student could simply hold the cube at eye level and place an anchored copy at that location, then be able to see the artifact in its actual size to a very precise measurement from all angles. The student could walk all the way around the floating statue and appreciate the details of every side, even underneath. Due to its precise execution, this embodiment of the system could be used in engineering and design, allowing for both hand-held examination of industrial products or parts and precisely scaled and placed items. This embodiment allows the user to evaluate both fine details and appropriateness of size and placement of the virtual object in an environment.

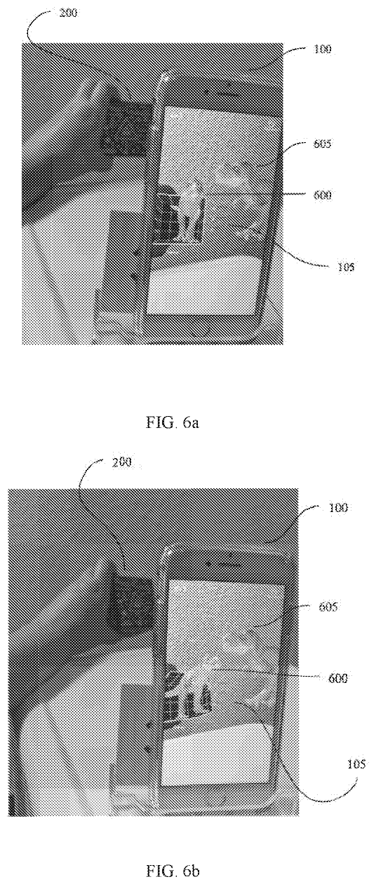

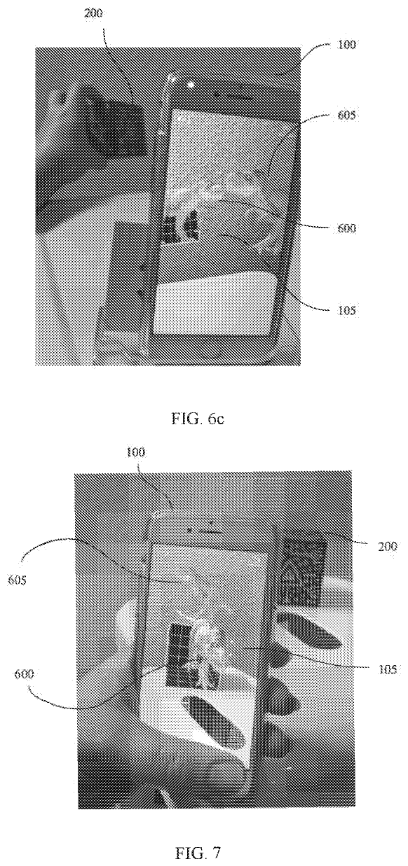

FIG. 6a-6c show how the change in the orientation of the cube 200 controls the orientation of the associated virtual object 600, in this case a dinosaur. The scene shown on the display 105 of the smartphone 100 already includes an anchored copy of the virtual dinosaur 605.

This illustrative embodiment shows how even a slight change in the orientation and position of the cube results in a similarly slight change in orientation and position of the associated virtual dinosaur 600. Taking advantage of the cube's three-dimensional nature, this change of orientation or position can be 360° in nature to provide the user with the exact orientation desired for the virtual object. This system allows for precise placement and positioning of the associated virtual dinosaur in the exact place that the viewer would like it to appear in the augmented reality world. Once the user had found the desired position for the associated virtual object 600, a copy can be anchored in exactly that spot. Being able to place the virtual object in air rather than relying on anchoring it to a planar surface of the user's environment provides a versatile, intuitive, and easy interface for the user of an augmented reality system.

Though the system provides a unique ability to anchor a virtual object not tied to a planar surface of the user's environment, the unique features of the cube 200 itself, in embodiments using a cube 200, make it easily placed on, next to, and near physical surfaces for anchoring of virtual objects. FIG. 7 shows an embodiment involving placing the cube 200 on an actual surface in the user's environment for precise placement of the associated virtual object 600 in the scene shown on the smartphone 100. This embodiment improves the ease of adjusting an orientation of a virtually placed object by offering exact orientation in a natural way as would be available if physically rotating the virtual object on a table.

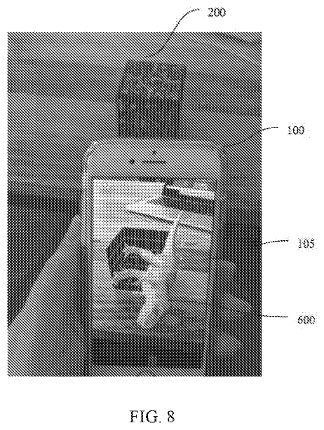

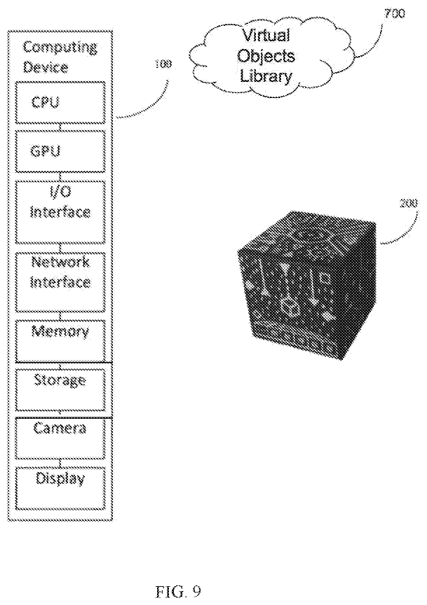

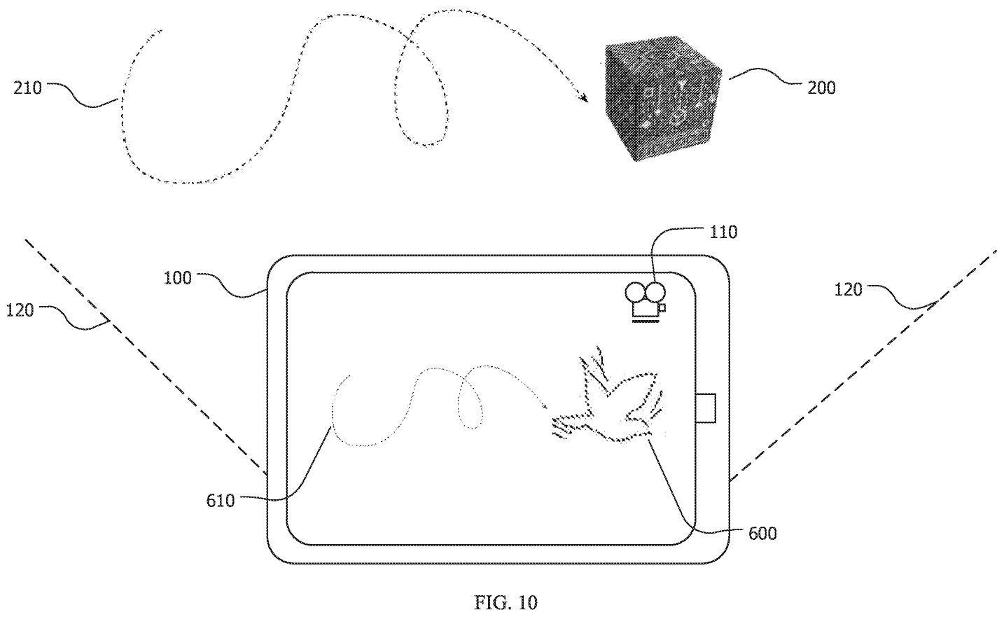

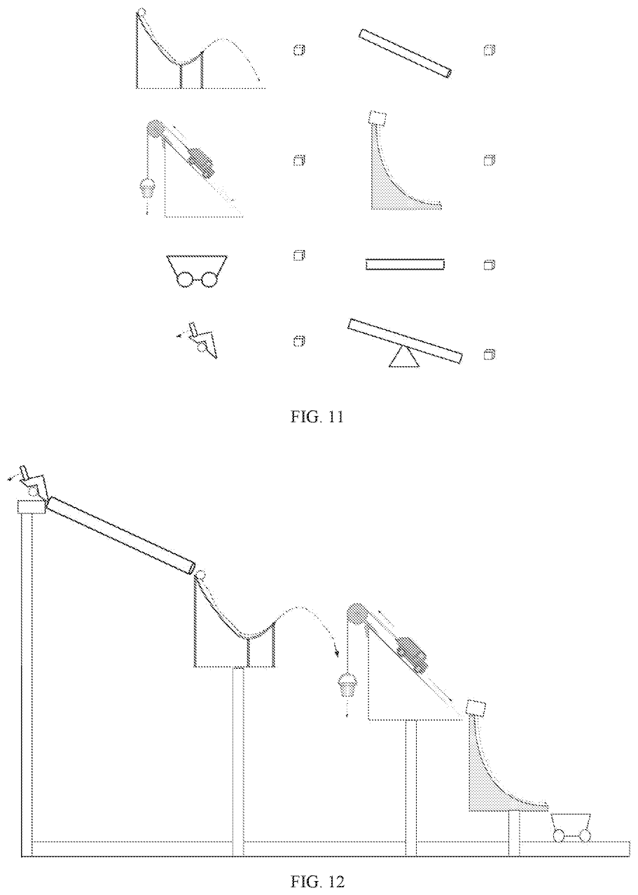

In FIG. 8 the virtual object 600 is shown on its side because the cube is on that side. In this case the cube 200 was placed on a table in an upright position and was then rotated 90° to the right as shown by the cube 200 being one its side. 90° and 180° rotations in any direction are very easy and precise to accomplish due to the shape of the cube. Once set on the table, the cube 200 can be rotated with precision to any fraction of a degree on the surface of the table, just as the virtual object 600 would be if it was sitting on the table.

The copy of the virtual object does not have to be a stationary three-dimensional image. It can be animated (e.g., a dancing character). The placement can be a starting point for the placed virtual object to travel in a planned direction or path. The character can travel a set path and then disappear. For example, when used in building a virtual scene, a virtual bird can be placed on a ledge, and then fly out a window in a user's environment.

Other embodiments use more elaborate animation techniques. For example, in one embodiment, the cube is used both as a placeholder and to track the rate and path of an animated character. Very easily and intuitively, a user moves the cube which corresponds to one-to-one movement of the animated object. The animation is tied to the cube movement as well such that the natural way a virtual object would move is animated realistically on the display of the system. For example, if the user chooses a soldier as the virtual object shown in the display, the motion shown would be appropriate and correspond to the speed of the trackable three-dimensional physical object (or cube). Moving the cube at a fast pace across the camera view would show the soldier running on the display; as the cube slows down, the animation of the soldier's legs slow down correspondingly. (Both the camera and the display could be movable, such as when they are incorporated into the same device. In this case, a user could move both in space, continuously updating the field of view of the camera, and consequently the path of the soldier can be everlasting.) When the cube stops, so does the soldier.

Other motions of the cube could correspond to different actions in the virtual soldier. For example, a 360° rotation could correspond to a front or back flip. A 90° turn towards the surface, when the cube is touching a surface, could correspond to a crouching motion for the soldier. Rocking the cube 45° toward each alternating corner could correspond to an army crawl. Lifting the cube from the surface may correspond to a jumping animation in the soldier. Endless motions with corresponding characteristics could be associated with the virtual character chosen by the user and housed in a virtual object/character library. The library could be in the storage attached to the computing device or stored on a server in communication with the computing device or in any other location that could be accessed by the computing device.

Other types of animation for movement are disclosed by the invention based on the selection of virtual object. In one embodiment, if the user selects a bird as the virtual object, moving across a surface would animate the bird in walking form. Lifting the cube may correspond to flapping of the wings at an appropriate rate to correspond to the speed of the cube. Fast movement through the air would correspond to equally fast flapping of the wings of the bird. When the cube is brought to a stop, the wings would slow down appropriately to land on a surface in the real world, or to a virtual tree or other object in the virtual scene the user is creating. The display would show a realistic transition of the wings from flying to landing, with the wings extended to aid in landing. The user can choose to record the animation, or even associate the entire path of the virtual object with that virtual object so that at the user's selection of the virtual object in a user interface, the virtual object will automatically follow the recorded path.

The virtual objects can also have predictable interactions or responses to each other. For example, in the example with the bird landing in a tree, the tree could be a virtual tree. The virtual bird could recognize that it is near another virtual object and have a predetermined interaction script when near that other virtual object. Multiple objects could be placed which have a variety of interaction schemes depending on the virtual object with which they are interacting (or physically close to). One other example is that of a virtual barrel on the ground in a scene, and a user making his virtual avatar travel towards the barrel.

The avatar could have a predetermined interaction plan with the barrel such that when the avatar reaches the barrel, it jumps over it. Other environmental virtual objects can have other logical interaction directions when interacting with other virtual objects or characters. It is important to note that the movement of the virtual object from one place to another itself can be animated without animating the action movements of the virtual object itself. For example, regarding the virtual bird, its movement across the display of the computing device could appear just as movement of the bird across the screen without the necessity of showing the wings flapping.

One other embodiment worth mentioning is a system with the virtual object being a vehicle such as a car. The wheels of the virtual car spin slowly with slow cube movement, or fast if appropriate based on the rate at which the cube moves. Turning the cube in space or on a surface may cause the virtual front wheels to turn as well in an appropriate manner to show realistic animation.

There are many animation embodiments that a user might use in various ways. A user could use the animation system for creating a story scene. An entire storyboard can be created for planning a movie for the filming industry. A teacher could create educational content. An expert witness in a trial could recreate an accident scene for a jury to view for better understanding of an automobile collision. A child could endlessly create imaginative scenes, and share them with friends. Animation in this disclosure is not limited to movement features.

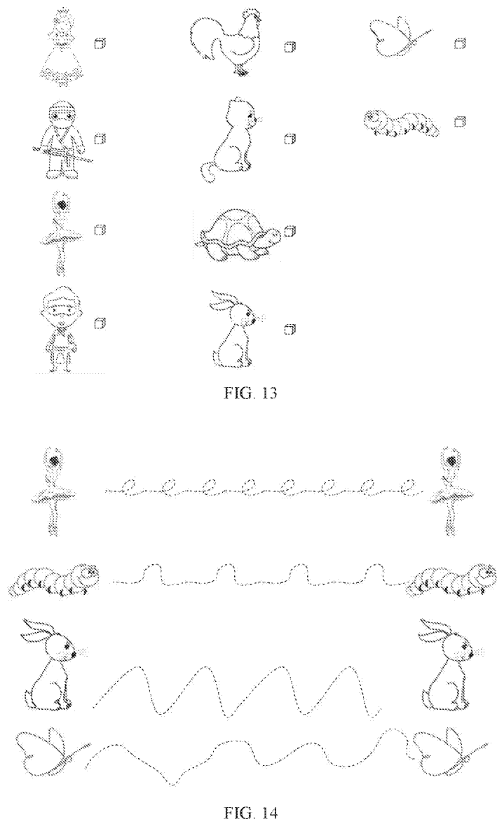

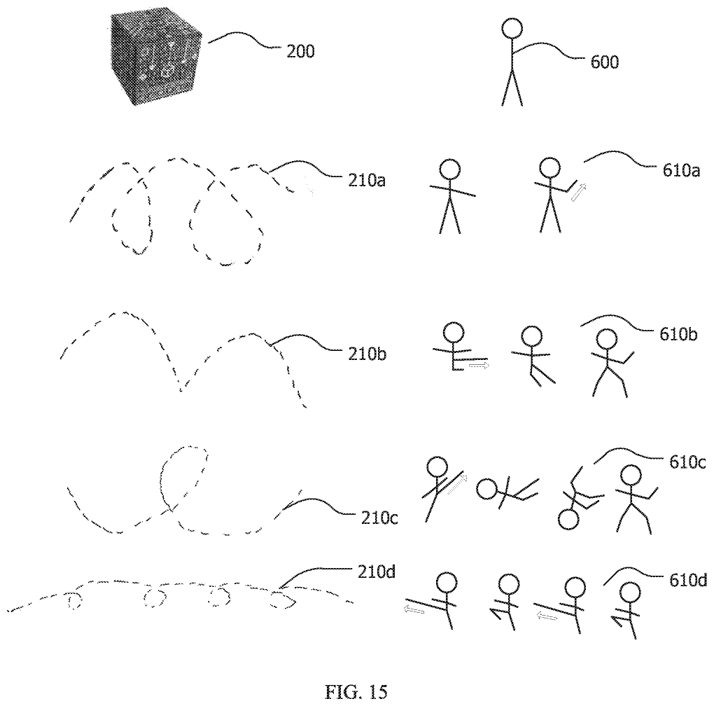

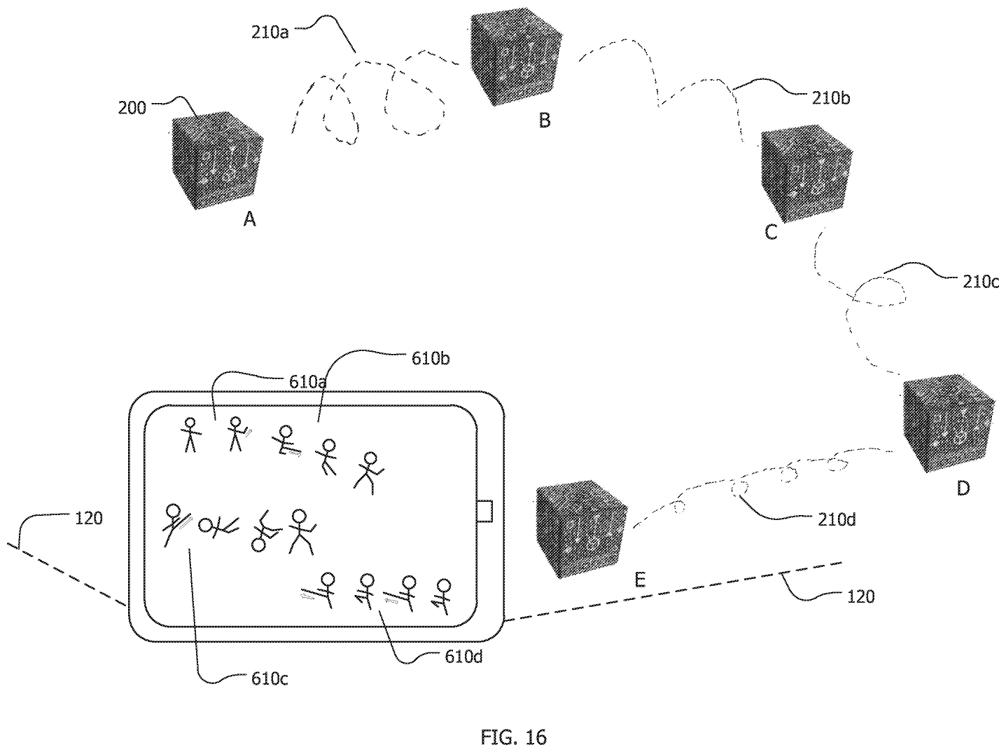

Animation could be in the scale of the virtual object or even its opacity. Many different libraries could be used to enhance the disclosed system and method. In one embodiment shown in part in FIG. 13 and FIG. 14, the available library 700 includes virtual objects and/or characters that have known courses of travel. Some examples of typical characters that may be used in the system are shown in an example display interface in FIG. 13. A virtual character library could include grouped related characters (e.g, animals, a royal court, superheros, insects, book characters) or a variety of unrelated characters. Each of these characters may have known characteristics in the way it travels, or may have an array of options for the user to associate with that character at various points in the user's environment (some of these embodiments are illustrated in FIG. 15 and FIG. 16).

FIG. 14 illustrates one embodiment providing an example of an interface showing characters that have associated characteristics of travel. The ballerina might move from point A to point B by spinning in circles. The rabbit might hop. If the user associated the virtual rabbit with the cube and moved the cube within the field of view of the camera, the display would show the rabbit's animation as hopping, but the path of movement would follow that of the cube through the user's environment. In the alternative, the user could use the cube to choose a starting and ending point in his environment for the rabbit (through stamping or some other user selection). Then, at the user's selection, the system will animate the tweening between point A and point B with the predictable characteristic motion for the chosen character, in the case of the rabbit, the animation would be hopping. Other non-limiting examples of characters with predictable movement may be a caterpillar with typical contraction and extension motions; a rabbit with a hopping motion; and a butterfly with fluttering motion that rises and falls in the air seemingly randomly. Characters and associated movement options are endless. In this embodiment the user stamps (or otherwise indicates) the starting point and/or end point for the path of the virtual character/object in his environment.

Other embodiments disclose a system in which a character has multiple movements that are associated with it. The user can select the character and movement to associate with the cube at various points in the user's environment. This selection could be made on the user interface or via specific movements of the cube. FIG. 15 illustrates potential examples of certain movements of the cube and the corresponding movements in the virtual object. The virtual object illustrated for exemplary purposes is a ninja 600. Full loops such as those illustrated by the movement line 210a correspond to large exaggerated steps in the ninja as shown in the images 610a. Large hopping motion of the cube shown at 210b corresponds to a jump and kick for the ninja shown at 610b. Each cube motion or interface motion indicator (210a-d) corresponds to a virtual character animation (610a-d). Because of the ability to track even slight movements in position, rotation, and orientation of cube (or other trackable three-dimensional physical object) due to its shape and multi-layered markers, endless movements can be both tracked and assigned to specific actions of the virtual character; thus the example interface in FIG. 15 is not intended to be limiting. With this disclosed system, a user can create complex animations easily and intuitively.

FIG. 16 is an embodiment of the disclosed system showing the display of the computing device 100 with the virtual animation shown corresponding to the user selected movement for each path in the user's environment. Between points A and B, the user selected motion characteristic 210a which has corresponding action in the virtual object of 610a which is shown on the display of the computing device 100. The computing device 100 in this embodiment of the system includes an incorporated camera; the field of view of the camera is indicated by the dotted line 120. Two methods of implementation by the user of this embodiment of the disclosed system are either utilizing the stamping feature in conjunction to a selection on the user interface to control points at which motion should change or using specific motions of the tracked cube to determine the motion of the virtual object. Both of these methods may utilize a virtual character motion table or library or other methods known in the art to associate the specific cube or interface motions with the virtual character animation like the example in FIG. 15.

Using the anchoring in conjunction with user interface table selection, a user would choose a character to associate with the cube, available movements would be viewable and selectable on an interface of the computing device such as a touchscreen of a smartphone. The user would select a desired motion, and “stamp” a starting point in the user's environment for that motion, a path would be tracked, and “stamp” a stopping point. In this embodiment, “stamp” is used in the sense that a copy could be created to show the user the place in the environment where the user has elected to change the type of animation characteristic motion associated with the virtual character and the path by which the virtual object should travel.

There does not have to be a copy created like in the earlier described “stamp” embodiment; some other indication of a change in associated characteristic motion at that point could be used.

In FIG. 16, there is no “stamp” shown, rather there the full animation is shown as if the entire sequence could be viewed simultaneously, for purposes of illustration. Between points A and B, the user selected virtual motion 610a, between points B and C the virtual motion chosen was 610b, the path from C to D is assigned 610, and D to E is virtual motion 610d. Again the user can choose the motion between the stamped points on the user interface, or the user could simply move the cube in the path from the library that corresponds to the desired movement of the virtual object, without “stamping” a point in the environment, and the system will recognize the tracked motion, and insert the appropriate corresponding animation of the virtual character or object. A user that moves the cube in a large looping pattern 210a will by that trackable motion, be creating the large step animation in the virtual ninja on the display. If the user moves the cube to make smaller loops with a longer distance them like in 210d, the ninja animation shown will be a crouched side kick. Again, the virtual animation can be viewed on the display in real-time and recorded (using the record feature 110) for playback in some embodiments, or planned ahead using the stamping method, for full playback with the virtual character at a later time in other embodiments.

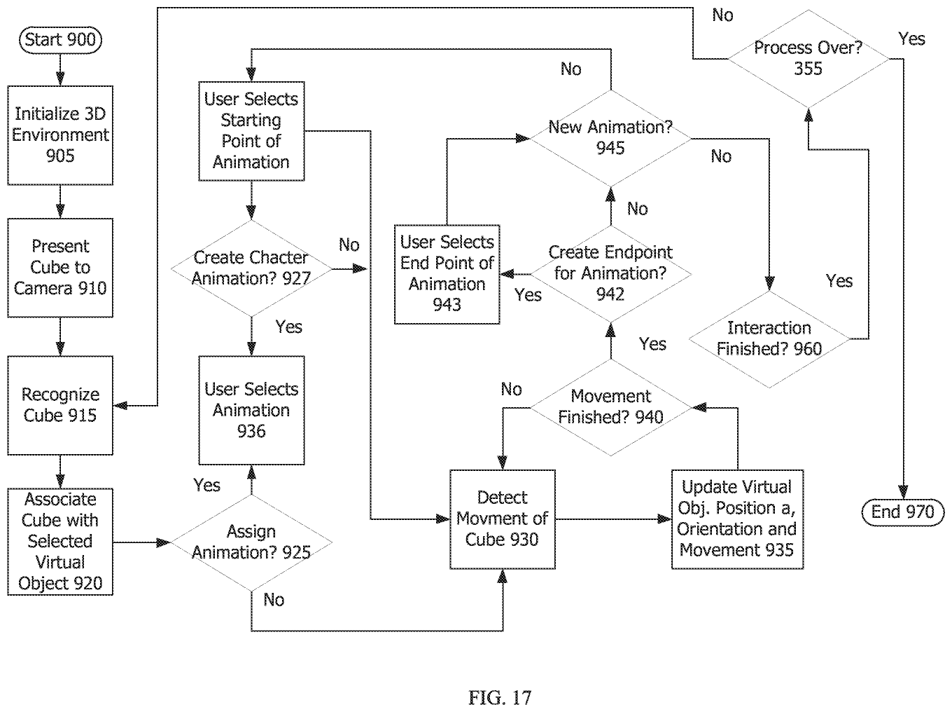

A flowchart for an example process for creating a path for a virtual object with discrete intervals of chosen animation is shown in FIG. 17. The initial steps of the process are similar to other processes already described: the environment is initialized, the cube is presented to the camera, the cube is recognized, the cube is associated with a selected virtual object. At step 925 is when the process may change at the decision step determining whether to assign an animation. If yes is chosen at 925, the process continues to allow the user to select the animation at 926.

The selection could be made on a user interface that presents the user with a library of animations associated with the chosen virtual character, or via some movement of the cube to select the animation. Next at decision step 927, it is determined whether segmented animation is desired. If yes at 927, the user will be determining a set path for each type of animation for the chosen virtual character. At 928 the user selects a starting point of the portion of the character's path that has the selected animation assignment. Next at 930, the system detects and tracks movement of the cube. At 935, the system updates the position, location and any chosen animation as the cube is moved in the field of view of the camera. At decision step 940, it is determined whether the movement of the cube is finished. The stop in movement could indicate a number of choices for the user. In this example process highlighting starting and stopping points for changes in animations, the next step 942 is a decision step determining whether the user wants to create an endpoint for the particular animation. If yes is chosen at 942, the user selects an endpoint at the location of the cube at 943. If no is chosen at 942, or once the user has selected an endpoint, it is determined at 945 whether the user wants to assign a new animation. If yes at 945, the process cycles back to 926 where the user assigns a new animation, and then follows the previously described process again, and again, until at 945 it is determined that the user does not want to assign a new animation to the selected virtual object. The process then continues to 960 where it is determined if the interaction is finished. If the interaction is not finished, the process cycles back to 920 allowing the user to assign a new virtual object to the cube. Here the user can continue creating a scene with a new virtual object, cycling through the previously discussed process allowing for various animations.

This cycle can continue through various virtual characters and their associated animations until the user is finished with the interaction. Once the interaction is finished, it is decided at 965 if the process is over; if yes, the process ends at 970. If the process is not determined to be over at 965 (maybe the cube was out of the camera view for the moment), the process cycles back to 915 where the cube is recognized.

In other embodiments, the user creates the path, including the rate and direction of travel of the virtual object, by recording the cube path. That movement can be viewed in real time on the display, or it can be saved and assigned or associated with the virtual object, so that whenever the virtual object is stamped, that path is associated with that object, and the stamp creates the starting position for the virtual copy. Here too, the animation of the virtual object is robust in that movement in various ways is realistic looking. The movement of the virtual object also can be recorded for playback in a scene, or saved and associated with that virtual object for insertion into a more elaborate, complete scene that may include multiple virtual objects. This scene creation can be used in many situations from education to industry. Scene creation for story telling is a particular area that could benefit from this invention. In areas such as education, even a very young child learning to read can show comprehension, by retelling a story that he read or that was read to him using an embodiment of this system.

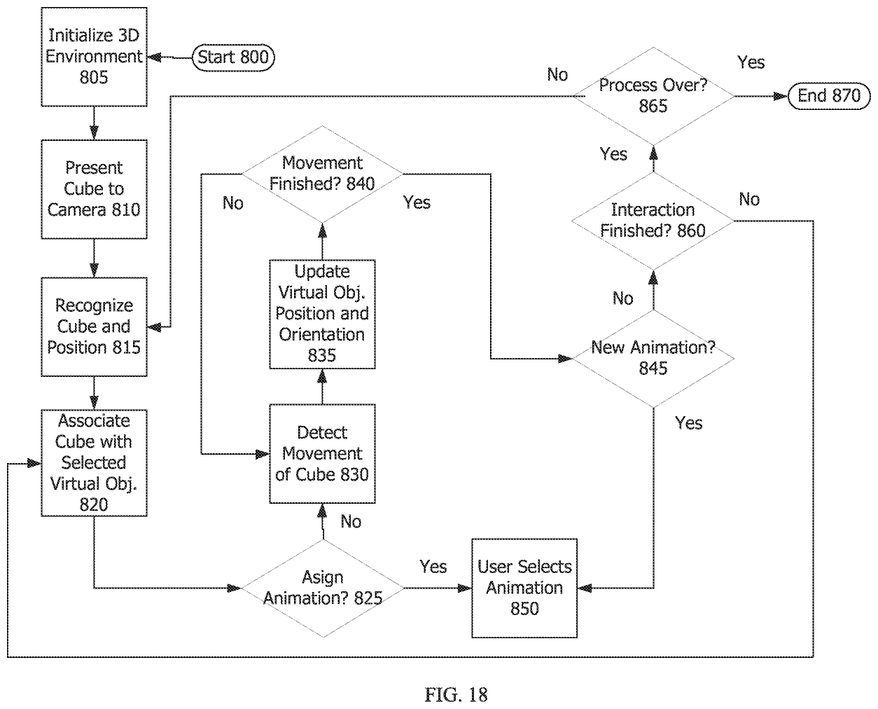

FIG. 18 illustrates one embodiment of a process that may be used in creating a scene using the trackable physical object (in this case a cube with a unique marker on each of its sides is used) that may include multiple virtual objects as well as assigning multiple animations to each of the chosen virtual objects. The process begins with initializing the user's environment at 805. This can include mapping of the physical space as discussed previously. The cube is presented to the camera in communication to the computing device at 810. At 815 the cube is recognized as an object that can be tracked in both location in the initialized environment as well as tracked in both position and orientation. At 820 a virtual object is associated with the cube.

This selection could be made by the user, or it could be automatically selected by the processor based on the software used. At decision step 825, it is determined whether to assign an animation to the virtual object. If yes at 825, the user can select an animation at 850. If multiple animations are not available, the default animation for that virtual object would be assigned at this point. If a list of animations is available, the user would select which animation to apply to the virtual object at step 850. The selection could be made on a user interface of the display, or could be made by a predetermined movement of the cube itself as discussed regarding FIGS. 14-16.

Next, movement of the cube is detected at 830. And at 835 the position and orientation of the virtual object is updated based on that tracked movement of the cube; this is also the step where the animation is shown in the virtual object. If animation was assigned, the movement falls in line with the chosen animation. At decision step 840, it is determined whether movement of the cube is finished. Parameters for this and other similar steps already discussed regarding FIGS. 3-5, would apply in describing parts of this process as well.

If “no” at decision step 840, and movement is not finished, the process cycles back to detecting (and tracking) movement of the cube at 830. If the movement is finished at 840, at 845 it is determined whether the user wants to assign a new animation to the current virtual object. If “yes” at 845, the process cycles back to 850 where the user selects an animation and then cycles back through the processes that have been discussed. If “no” at 845, it is determined at 860 whether the interaction is finished. If the interaction is not finished, the process cycles back to 820 to associate a different virtual object with the cube, and the process continues from there. If it is determined that the interaction is finished at 860, it is determined whether the process is over at 865. If “no” at 865, the process goes back to recognizing the cube at 815. If the process is over at 865, the process ends at 870.

Another animation embodiment of the invention includes a physics engine. The physics engine could be a set of algorithms that rule how the various user selected virtual objects interact. It can be implemented in various ways known in the art; one embodiment may use a virtual objects library. The virtual object library in some embodiments can include various objects that have known physical properties in the real world and are predictable or logical in how they interact with other objects in the real world. These known properties can be associated with the virtual counterparts, and interaction models can be associated within the virtual library. These properties could be widely varied, including materials, coefficients of friction, sounds made while moving in various environments, and any other properties which might be useful to create a realistic animation. These virtual libraries could include all number of virtual objects; they could be all encompassing, or include only a small subset of related objects.

As discussed earlier with the example of an avatar jumping over a barrel, various virtual characters or objects can have a set of interaction directions based on certain environmental factors. This interaction could be predictable and logical such that a small virtual bird landing on a tree would not affect the location of the virtual branch upon landing due to its light “weight”. However, a virtual jungle cat landing on the same branch would create a depression of that same virtual branch as it is a much “heavier” animal. It is important to note that these interactions are not limited to physical embodiments. Other interactions may be available, such as verbal ones when used in embodiments with audio recording capabilities. For example, a group of virtual characters related by a commonly known storyline, can have predictable dialogue built-in that is activated by proximity to other placed virtual characters for a more robust scene creation embodiment. A virtual pirate might demand a stowaway to “walk the plank” as the virtual stowaway moves near his placed position in the virtual world.

One example of an embodiment including realistic implementation of predictable physical properties is in the form of a Rube Goldberg machine. The virtual objects could be various ramps, levers, and pulleys among other things. A user would associate the virtual ramps, slides, tunnels, and pulley systems with the cube, place the various pieces in the environment together precisely, using the cube, or even multiple cubes if chosen for better accuracy in placement. As the cubes stack and can be placed easily and naturally in an environment, the user would have a simple and intuitive method of placing the virtual pieces in the physical environment. The characteristics associated with each piece of the machine would allow a virtual marble or other object to travel along the “surfaces” of the virtual pieces in a realistic way, as it would in a physical environment. The material chosen for the surfaces of the parts of the machine would also operate realistically. Materials with more friction on the surface would result in slowing the marble, where slicker materials would result in a faster marble movement.

It should be noted that as the computer vision can track flat surfaces in the user environment, those could be incorporated with the virtual ramps, levers and other simple machines. For example, a virtual marble could appear to travel from a virtual ramp to a tabletop that exists in the physical environment, and then falls into a virtual bucket to continue on its virtual path. Multiple variations can be created using a combination of both virtual objects and physical surfaces that are recognized by the camera and associated software by the processor.

The sound associated with a marble rolling across the various materials may also be realistic and located realistically to the user. For example, the sound of a glass marble traveling over a wooden ramp, would be different than if the ramp was metallic. That the marble speeds up going down the ramp with increased velocity due to gravity would be seen and evident in the sound of the marble as it travels down the ramp. If the marble then lands in a bucket of water, the user would experience a plopping sound when the marble hits the “water”. The sounds in the scene while true to the material of the virtual object could also be true to the location of the object in relation to the camera. As the object travels across the environment from left to right, the associated sound also seems to travel from left to right. All aspects of the virtual object creation, animation, and sound are able to be recorded for playback. Sounds can also be tied to real world elements. For example, virtual water being poured out of a virtual container onto a physical surface in the user's environment would make a splashing sound as it hits the physical surface. Similarly, a virtual glass being dropped on the user's floor would not only fall at a predictable rate due to gravity, the user would hear a shattering sound as it hits the floor.

Recording may be available in any embodiments disclosed, and may be initiated at any point in the process of using the system. The user can also view and control virtual (and possibly animated) objects associated with the cube in real-time without the need to record the interaction.

Closing Comments

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

It is claimed:

1. A method for anchoring a virtual three-dimensional object in a physical environment in a physical location using a trackable three-dimensional physical object, the method comprising:
detecting attributes of a three-dimensional physical environment using at least one of a camera, infrared, LIDAR, and motion detection;
initializing a virtual three-dimensional environment corresponding to the three-dimensional physical environment;
detecting a trackable three-dimensional physical object in the three-dimensional physical environment within the view of a camera in communication with a computing device;
generating a three-dimensional virtual object on a display of the computing device in place of the trackable three-dimensional physical object;
tracking movement of the physical object over a predetermined period of time to define movement of the three-dimensional virtual object; and
updating a position, orientation, and location of the three-dimensional virtual object in the three-dimensional physical environment visible on the display based upon the movement.

2. The method of claim 1 further comprising positioning the three-dimensional virtual object anchored to a position of the trackable three-dimensional physical object in the three-dimensional physical environment in response to user input directing the computing device to retain a position of the three-dimensional virtual object.

3. The method of claim 2, wherein positioning the three-dimensional virtual object anchored to the position of the trackable three-dimensional physical object comprises scaling the three-dimensional virtual object to a predetermined size.

4. The method of claim 1, wherein generating the three-dimensional virtual object comprises scaling the three-dimensional virtual object to the size of the three-dimensional physical object.

5. The method of claim 1, wherein the trackable three-dimensional physical object comprises a cube bearing at least six unique markers, with at least one on each of its sides.

6. The method of claim 1, further comprising:
tracking a path through which the trackable three-dimensional physical object passes through the three-dimensional physical environment; and
creating a corresponding animation of the three-dimensional virtual object based on the path.

7. The method of claim 6 further comprising:
tracking an orientation of the trackable three-dimensional physical object through the path; and
creating a corresponding animation of the three-dimensional virtual object based upon the orientation at multiple points during the path.

8. The method of claim 1, further comprising storing the position, orientation, location, and movement of the virtual object throughout a predetermined time.

9. A system for anchoring a three-dimensional virtual object in a physical environment displayed on a computing device comprising:
a trackable three-dimensional physical object;
a camera in communication with a computing device;
the computing device including a memory, a display and a processor, the processor configured to:
detect attributes of a three-dimensional physical environment;
initialize a virtual three-dimensional environment corresponding to the three-dimensional physical environment;
detect the trackable three-dimensional physical object in the three-dimensional physical environment within the view of the camera in communication with a computing device;
generate a three-dimensional virtual object on the display of the computing device in place of the trackable three-dimensional physical object;
track movement of the physical object over a predetermined period of time to define movement of the three-dimensional virtual object; and
update a position, orientation, and location of the three-dimensional virtual object in the three-dimensional physical environment visible on the display based upon the movement.

10. The system of claim 9 wherein the processor is further configured to position the three-dimensional virtual object anchored to a position of the trackable three-dimensional physical object in the three-dimensional physical environment in response to user input directing the computing device to retain a position of the three-dimensional virtual object.

11. The system of claim 10, wherein positioning the three-dimensional virtual object anchored to the position of the trackable three-dimensional physical object comprises scaling the three-dimensional virtual object to a predetermined size.

12. The system of claim 9, wherein to generate the three-dimensional virtual object further comprises scaling the three-dimensional virtual object to the size of the three-dimensional physical object.

13. The system of claim 9, wherein the trackable three-dimensional physical object comprises a cube bearing at least six unique markers, with at least one on each of its sides.

14. The system of claim 9, wherein the processor is further configured to:
track a path through which the trackable three-dimensional physical object passes through the three-dimensional physical environment; and
create a corresponding animation of the three-dimensional virtual object based on the path.

15. The system of claim 14 wherein the processor is further configured to:
track an orientation of the trackable three-dimensional physical object through the path; and
create a corresponding animation of the three-dimensional virtual object based upon the orientation at multiple points during the path.

16. The system of claim 9, wherein the processor is further configured to store the position, orientation, location, and movement of the virtual object throughout a predetermined time.
